(19) United States
(12) Patent Application Publication
(10) Pub. No.: US 2011/0130150 A1
(43) Pub. Date: Jun. 2, 2011

(54) METHODS AND APPARATUS FOR SERVICE-AWARE ENERGY SAVING AND LOAD BALANCING OPERATIONS

(75) Inventors: Troels Emil Kolding, Klarup (DK); Frank Frederiksen, Klarup (DK); Lars Delsgaard, Oulu (FI); Jeroen Wigard, Klarup (DK)

(73) Assignees: NOKIA CORPORATION, Espoo (FI); NOKIA SIEMENS NETWORKS OY, Espoo (FI)

(21) Appl. No.: 12/628,728

(22) Filed: Dec. 1, 2009

(51) Int. Cl. H04W 72/00; H04B 1/38; H04B 17/00

(52) U.S. Cl. 455/453; 455/574; 455/67.11

(57) ABSTRACT

In accordance with an example embodiment of the present invention, a method comprises establishing a plurality of mode priorities one for each of a plurality of technology modes supported by a user equipment (UE) and selecting a target technology mode that meets at least one current user service requirement of the user equipment and maximizes a power saving based at least in part on a mode priority associated with the target technology mode. The method also includes causing the user equipment to camp on the selected target technology mode and balancing a resource allocation based in part on the selected target technology mode.

### TECHNICAL FIELD

The present application relates generally to method and apparatus for service-aware energy saving and load balancing operations.

### BACKGROUND

It is not uncommon that a wireless device such as a 3^{rd} generation (3G) user equipment (UE) supports multiple technology platforms in order to at least support backward compatibility and interworking of different technology platforms. For example, a 3G UE may support a 2^{nd} generation (2G) technology platform to be backward compatible with the widely deployed 2G networks. For another example, a cellular UE may support a wireless local area network technology platform so that the cellular UE may seamlessly roam between a cellular network and a wireless local area network.

Support of multiple technology platforms simultaneously may consume more energy than otherwise. For example, a UE supporting both 3G and 2G technology may scan for beacon messages of both 2G and 3G networks at the same time and thus may consume at least twice as much power as would otherwise. This may result in an undesirable, shorter battery life for a battery-powered mobile device such as a UE.

### SUMMARY

Various aspects of examples of the invention are set out in the claims.

According to a first aspect of the present invention, a method comprises establishing a plurality of mode priorities one for each of a plurality of technology modes supported by a user equipment (UE) and selecting a target technology mode that meets at least one current user service requirement of the user equipment and maximizes a power saving based at least in part on a mode priority associated with the target technology mode. The method also includes causing the user equipment to camp on the selected target technology mode and balancing a resource allocation based in part on the selected target technology mode.

According to a second aspect of the present invention, an apparatus comprises a service profile control module configured to establishing a plurality of mode priorities one for each of a plurality technology modes supported by a user equipment; and select a target technology mode that meets at least one current user service requirement of the user equipment and maximizes a power saving based at least in part on a mode priority associated with the target technology mode. The apparatus also comprises an interface module configured to cause the user equipment to camp on the selected target technology mode and disable at least one operation for each of the plurality of technology modes that is not the selected target technology mode if a priority mode associated with the technology mode reaches a low threshold. The apparatus also comprises a resource control module configured to balance a resource allocation based in part on the selected target technology mode.

According to a third aspect of the present invention, an apparatus comprises at least one processor and at least one memory including computer program code. The at least one memory and the computer program code configured to, with the at least one processor, cause the apparatus to establish a plurality of mode priorities one for each of a plurality technology modes supported by a user equipment and select a target technology mode that meets at least one current user service requirement of the user equipment and maximizes a power saving based at least in part on a mode priority associated with the target technology mode. The at least one memory and the computer program code configured to, with the at least one processor, also cause the apparatus to cause the user equipment to camp on the selected target technology mode, disable at least one operation for each of the plurality of technology modes that is not the selected target technology mode if an priority mode associated with the technology mode reaches a low threshold; and balance a resource allocation based in part on the selected target technology mode.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example wireless network;

FIG. 2 illustrates an example method for determining a technology mode;

FIG. 3A illustrates an example method for updating a mode priority;

FIG. 3B illustrates an example method for selecting a technology mode based on the mode priority;

FIG. 4 illustrates an example apparatus for service-aware load balancing and power saving; and

FIG. 5 illustrates an example apparatus for implementing service-aware power saving and load balancing operations in accordance with an example embodiment of the invention.

### DETAILED DESCRIPTION OF THE DRAWINGS

A user's service usage pattern may be established for a considerable period of time. When a high degree of confidence is achieved that the user may not use services associated with a particular technology platform, some operations associated with the technology platform may be turned off to conserve power.

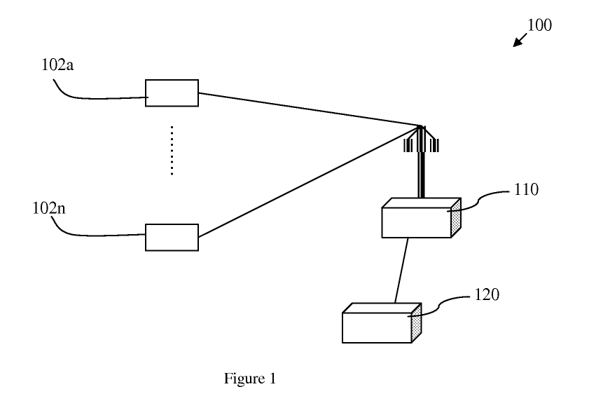

An example embodiment of the present invention and its potential advantages are understood by referring to FIGS. 1 through 5 of the drawings.

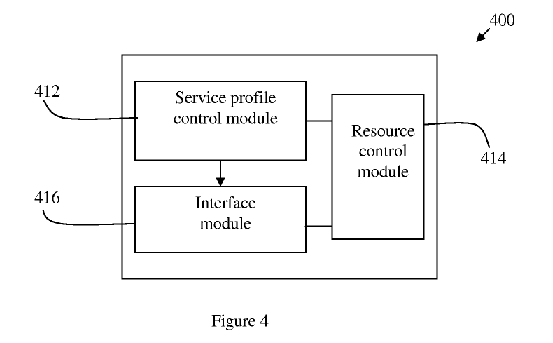

FIG. 1 illustrates an example wireless network 100. The example wireless network 100 includes a set of user equipments labeled 102a through 102n, a base station 110 and a mobility management entity 120. The base station may contain at least part of an apparatus 400 which is illustrated in FIG. 4 and described hereinafter. The mobility management entity 120 may also contain at least part of the apparatus 400.

In one example embodiment, the base station 110 is a long-term evolution (LTE) evolution node B (eNodeB). The eNodeB may provide radio related functions such as air interface function to associated user equipments in the cell and may provide aggregated traffic to an LTE core network. The mobility management entity 120 is a control node for an LTE access-network. It may be responsible for idle mode UE tracking and paging procedure including retransmissions. It may be involved in the bearer activation/deactivation process and responsible for choosing a signaling gateway for a UE at the initial attach and at time of intra-LTE handover involving an LTE core network node relocation. It may also be responsible for authenticating the user via interacting with other network nodes. The mobility management entity 120 may check the authorization of the UE to camp on a particular network platform, termed technology mode for rest of the specification, and enforce UE roaming restrictions.

The UEs 102a through 102n may support multiple technology modes such as a 2^{nd} generation (2G), 3^{rd} generation (3G) and 4^{th} generation (4G) at the same time. A technology mode may represent a wireless access technology, a wireless network standard, a networking platform, a service platform, and the like. An example technology mode is a wireless standard such as 2G or 3G technology mode.

In one example embodiment, the base station 110 or mobility management entity 120 may collect service usage data of a UE such as one of UEs UE 102a through 102n. Each time the UE 102a, for example, enters an active state such as activating the UE, and uses a service such as making a long distance voice call, the service usage data is collected. This service usage data item is recorded in a service profile control module. Similarly, if a 3G data service is used in the UE 102a, the service usage data is collected. The mobility management entity 120 and the base station 110 may collectively compute a mode priority for each technology mode such as 2G or 3G technology mode. Over a reliable period of time, a reliable mode priority may be established. If the UE tends to use the services such as voice call and message messaging, next time the UE 102a enters the active state, the base station 110 may automatically camp the UE 102a on the technology mode such as 2G that meet the service requirements and maximize the power saving and load balancing at the same time.

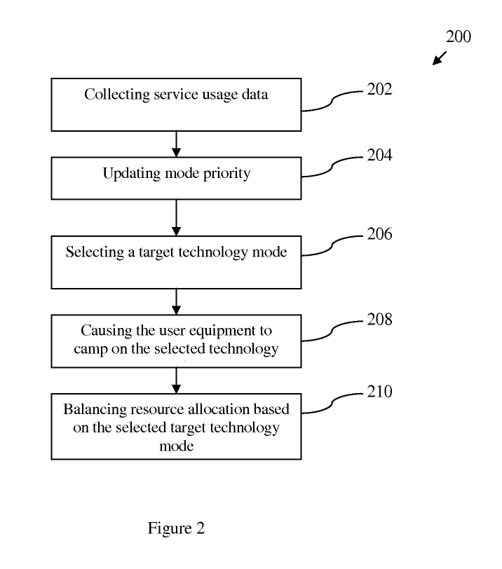

FIG. 2 illustrates an example method 200 for determining an appropriate target technology mode that meets a user's service requirements and achieve maximum power saving and load balancing. The method 200 may include collecting service usage data at block 202, updating a mode priority at block 204, and selecting a target technology mode at block 206. The method 200 may also include causing the user equipment to camp on the selected target technology mode at block 208 and balancing resource allocation based on the selected target technology mode at block 210.

In one example embodiment, collecting service usage data at block 202 may include collecting a multitude of service usage data for a reliable period of time. The service usage data may include a type of service, a duration of the service session, a technology mode with which the service is associated, and the like. The examples of the service type may include a 2G voice service, a Global System for Mobile communications (GSM) message service, a 3G data service, a 3G voice service, and the like. Collecting service usage data may include aggregating and filtering the service usage data. Aggregating the service usage data may include summarizing the data usage sessions into a service summary and aggregating multiple short sessions into fewer sessions. Filtering data may include filtering out data noises such as those failed service attempts in the service usage data.

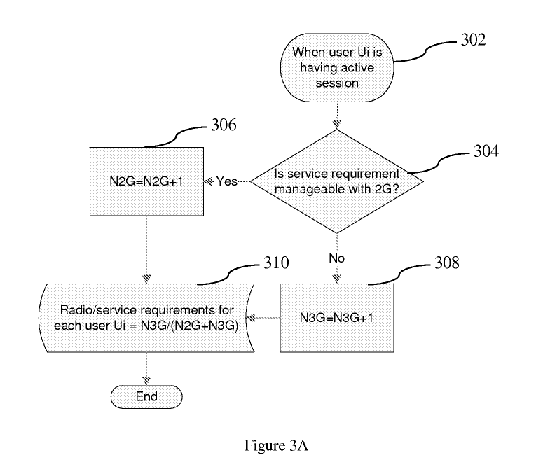

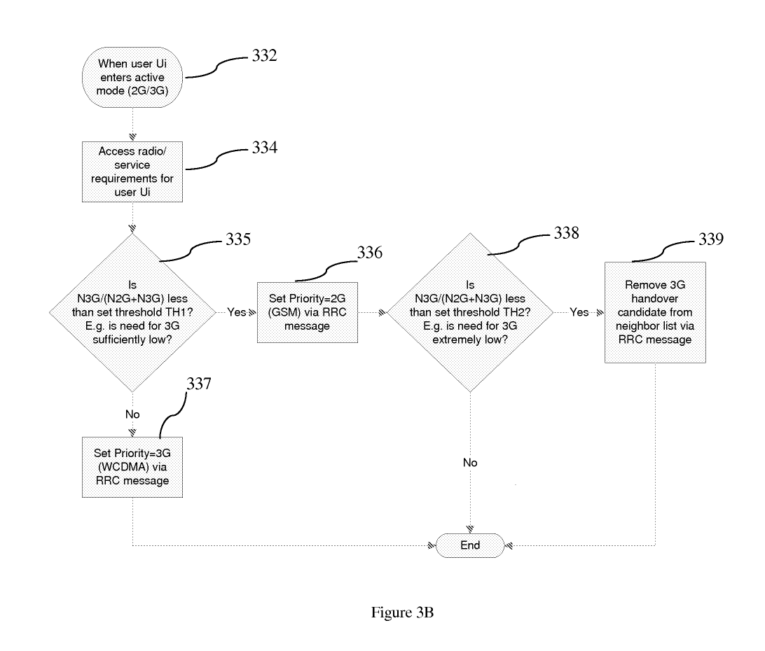

In one example embodiment, updating a mode priority at block 204 may include updating the mode priority based on the service usage data. The mode priority may indicate a preference for a technology mode for a UE. A reliable mode priority value may indicate the associated UE may be reliably camped on the associated technology mode. As such, the operations associated with other technology modes may be turned off to save power and the resources allocated to other technology modes may also be de-allocated and overall system-wide load rebalanced for maximum system-wide performance. Updating the mode priority may take place each time a new service usage data item is collected or periodically at a predetermined interval. Updating the mode priority may include maintaining a service usage frequency counter and incrementing a service usage counter associated with a technology mode such as 3G or 2G technology mode. Updating the mode priority may further include computing a mode priority of a technology mode as a probability of selecting the technology mode over other technology modes to meet service requirement of the UE. An example process for updating a mode priority is illustrated in FIG. 3A and described hereinafter.

In one example embodiment, selecting a target technology mode at block 206 may include selecting a technology mode that may best match the service requirement of a user equipment, with maximum power saving and a minimum possibility of missing an opportunity to afford the UE a chance to use other technology modes. For example, if the UE service requirement is for voice data, a better choice may be a 2G technology mode that provides voice service with minimum power consumption. At the same time, if the chance for the UE to use service of another technology mode, such as 3G data service is relatively high, then 3 G operations may not be disabled. On the other hand, if it is fairly certain that the selected technology mode would meet the UE's service requirement, power consuming operations of other technology mode may be disabled to converse power. An example embodiment of selecting the target technology mode is illustrated in FIG. 3B and described hereinafter.

In one example embodiment, selecting the target technology mode at block 206 may also include taking into account other factors such as UE types, subscribed service, a confidence level of the UE using the target technology mode. Selecting the target technology mode at block 206 may also include taking into account a user preference and an operator preference. A user may set a preference for a technology mode such as 2G or 3G services for various reasons. An operator may set a preference for a specific technology mode for a variety of reasons that may include revenue, a network resource allocation, and the like.

In one example embodiment, causing the user equipment to camp on the selected technology mode at block 208 may include sending a signaling message such as radio resource control (RRC) message to the associated UE to camp on the selected technology mode. The signaling message may also indicate whether to disable power consuming operations of other technology modes that are not selected, depending on the likelihood the UE may use those services associated with the technology modes that are not selected.

In one example embodiment, causing the user equipment to camp on the selected technology mode at block 208 may also include taking power saving related action based in part on the current operating state of the user equipment. For example, if the associated UE is in an active state and if a priority mode associated with the technology mode reaches a low threshold, the eNodeB may instruct the UE to disable some operation for a technology mode that is not the target technology mode. For example, if the 2G technology mode is selected and the mode priority for other technology modes such as 3G technology mode reaches a low threshold, the eNodeB may instruct the UE to disable the 3G related measurements for a 3G handoff. However, when the UE is in an idle state, the eNodeB may refrain from taking aggressive actions such as disabling power consuming operations such as measurements. At least part of reason for the different handling of the UE in the idle state is because the eNodeB's control of the UE in the idle state may be limited. In addition, the UE may be in a different network or have a different service requirement when the UE wakes up and enters the active state the next time.

In one example embodiment, balancing resource allocation based on the selected target technology mode at block 210 may include allocating resource for the selected technology mode. For example, if 3G technology mode is selected, radio resources related to the 3G services may be pre-allocated or reserved, depending on a specific service. Balancing resource allocation at block 210 may also include de-allocating the resource associated with the technology mode that is deselected in favor of the selected target technology mode. Balancing resource allocation at block 210 may also include balancing overall system-wide resource allocations based on the recent allocation and de-allocations of resources. The load balancing may be triggered by selecting a new target technology mode or at a fixed interval.

In an example embodiment, the method 200 may be partially implemented in the base station 110 and partially implemented in the mobility management entity 120 of FIG. 1 or in the apparatus 400 of FIG. 4. The method 200 is for illustration only and the steps of the method 200 may be combined, divided, or arranged in an order different than illustrated, without departing from the scope of the invention of this example embodiment.

FIG. 3A illustrates an example method 300A for updating mode priority based on a service usage data item. For illustration purpose, it is assumed that 2G and 3G are the available technology modes. In one example embodiment, the process 300A starts at block 302 to check whether a user equipment is in an active state. If the UE is in the active state and a service usage has occurred, the method 300A determines the technology mode with which the service is associated. In this example embodiment, a query is made at block 304 on whether the technology mode is 2G or 3G wireless technology that may meet the service requirement of the service just used. If the service usage is of the 2G technology mode, then a 2G service usage counter is incremented by 1 at block 306. Otherwise, it is a 3G service usage and the corresponding 3G service usage counter is incremented by 1 at block 308. After the usage counter is incremented, the mode priority is updated as a 3G usage ratio over a total service usage. The method 300A may be invoked each time a service usage data is collected and a reliable mode priority may be established over a reliable period of time.

FIG. 3B illustrates an example method 300B for selecting a technology mode based on a mode priority. For illustration purpose, it is assumed that 2G and 3G are the available technology modes. Each technology mode has an associated mode priority that is established from historical service usage data as illustrated in FIG. 3A and described therein. The process 300B may start when the UE enters an active state at block 332.

In an example embodiment, a service-aware power saving apparatus such as the apparatus 400 may determine a technology mode by first checking the service requirements of a user Ui at block 334. The user Ui may need voice service only or 2G data service and the voice service. A query checks whether the mode priority of the 3G technology mode is above a threshold value TH1 such as 50% or 70%. As explained earlier, the mode priority for the 3G technology mode may be represented as a ratio of 3G service usage frequency (N3G) to the overall service usage frequency (N2G+N3G), a ratio such as N3G/(N2G+N3G) in this example. The threshold value may be set according to a level of confidence in the historical usage data. For example, if the priority mode is based on historical data for past two days, the level of the confidence may not be very high. As such, the threshold value may be set relatively high. On the other hand, if the confidence level is relatively high, then the threshold value may be set relatively low. The threshold value may be set manually or automatically based on factors such as a subscription service, a UE type, and the like.

The technology mode is set to the 3G wideband code division multiple access (WCDMA) technology mode if the 3G mode priority reaches a threshold value at block 337 and the process of selecting the target technology mode may terminate there. On the other hand, the technology mode is set to 2G if the 3G mode priority fails to reach the 3G threshold value TH1 at block 336. The 2G technology mode such as GSM technology then becomes the selected target technology mode for the user Ui. A second inquiry is made at block 338 to determine whether the possibility of using the 3G technology mode is sufficiently low. If the possibility is sufficiently low to reach a lower bound threshold TH2, power-consuming operations for the 3G technology mode such as measurement for handover may be disabled at block 339. In this example embodiment, the 3G handover operation is disabled by removing the candidates from the handover candidate list. A radio resource control (RRC) message may be sent to the UE to disable the 3 G operation. On the other hand, if the mode priority for 3G technology mode is not sufficiently low, no further action is needed and certain default operations for 3G technology mode remain available for the user Ui.

The method 300B may be extended to accommodate more than 2 technology modes without departing from this example embodiment of invention. In an example embodiment, the method 300B may be implemented in the base station 110 or in the mobility management entity 120 of FIG. 1 or in the apparatus 400 of FIG. 4. The method 300B is for illustration only and the steps of the method 300B may be combined, divided, or arranged in a different order than illustrated, without departing from the scope of the invention of this example embodiment.

FIG. 4 illustrates an example apparatus 400 for service-aware power saving and load balancing operations. The apparatus 400 may include a service profile control module 412, an interface module 416 and a resource control module 414.

In an example embodiment, the service profile control module 412 may be configured to collect at least one service usage data item from a user equipment that may support multiple technology modes. The service profile control module 412 may also update a mode priority based in part on the collected service usage data items and select a target technology mode for the user equipment at least in part based on the updated mode priority of the at least one technology mode. The selected technology may meet the service requirements of the UE and maximize the power saving and load balancing at the same time. The service usage data may include at least a type of service used in a service session, a length of the service session, and a technology mode of the user equipment associated with the service. The type of service may be a voice call, an instant message, a 3G data service, a 2G data service and the like. The mode priority may be represented as a ratio of a service usage frequency for a technology mode to the service usage frequency of all available technology modes.

In an example embodiment, the interface module 416 may be configured to cause the user equipment to camp on the selected target technology modes. The interface module 416 may instruct the user equipment to enable the service associated with the selected target technology mode. The interface module 416 may disable those service not associated the selected target technology mode if the chance for the UE to use those services is sufficiently low. The interface module 416 may send a radio resource control (RRC) message to the UE and the RRC message may include a resource allocation update, a camp priority, the selected target technology mode and the like.

In one example embodiment, the resource control module 414 may be configured to balance a resource allocation based in part on the selected target technology mode. The resource control module 414 may be configured to allocate at least one resource for the selected technology mode and de-allocate the resource allocated to a technology mode that is not the target technology mode.

The apparatus 400 may be part of an eNodeB, a mobility management entity, and a 4G network element. Part of the apparatus 400 may be implemented in one network element such as eNodeB 110 and part of the apparatus 400 may be implemented in another network element such as the mobility management entity 120 of FIG. 1. In one embodiment, the service profile control module 412 may be implemented in the mobility management entity 120 and the interface module 416 and the resource control module 416 may be implemented in the eNodeB 110 of FIG. 1.

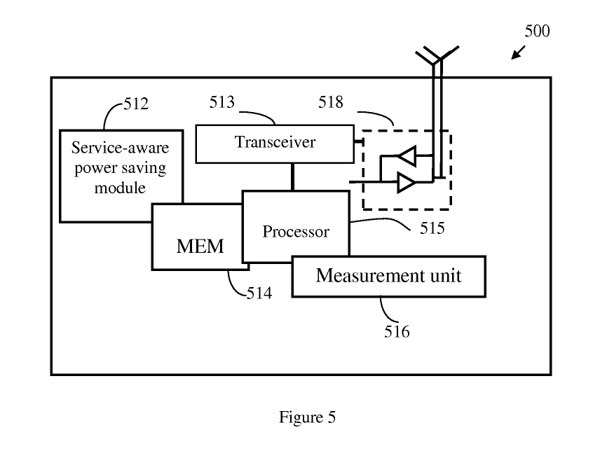

FIG. 5 is a block diagram illustrating an example wireless apparatus 500 for implementing service-aware power saving and load balancing operations in accordance with an example embodiment of the invention. In FIG. 5, the wireless apparatus 500 may include a processor 515, a memory 514 coupled to the processor 515, and a suitable transceiver 513 (having a transmitter (TX) and a receiver (RX)) coupled to the processor 515, coupled to an antenna unit 518. The memory 514 may store programs such as a resource control module 512, and a service-aware power saving apparatus 517. The wireless apparatus 500 may be at least part of a 4^{th} generation UE, and a LTE compliant base station. Part of the apparatus 500 may be part of a mobility management entity.

The processor 515 or some other form of generic central processing unit (CPU) or special-purpose processor such as digital signal processor (DSP), may operate to control the various components of the wireless apparatus 500 in accordance with embedded software or firmware stored in memory 514 or stored in memory contained within the processor 515 itself. In addition to the embedded software or firmware, the processor 515 may execute other applications or application modules stored in the memory 514 or made available via wireless network communications. The application software may comprise a compiled set of machine-readable instructions that configures the processor 515 to provide the desired functionality, or the application software may be high-level software instructions to be processed by an interpreter or compiler to indirectly configure the processor 515.

In an example embodiment, the service-aware power saving module 512 may be configured to select a target technology mode for the user equipment at least in part based on the updated mode priority of the at least one technology mode. The selected technology may meet the service requirements of the UE and maximize the power saving and load balancing at the same time. In an example embodiment, the service-aware power saving module 512 may be configured to cause the user equipment to camp on the selected target technology modes by instructing the user equipment to enable the service associated with the selected target technology mode. The service-aware power saving module 512 may disable those service not associated the selected target technology mode if the chance for the UE to use those services is sufficiently low.

In one example embodiment, the service-aware power saving module 512 may be configured to balance a resource allocation based in part on the selected target technology mode. The service-aware power saving module 512 may be configured to allocate at least one resource for the selected technology mode and de-allocate the resource allocated to those technology modes that may not be needed at any more.

The transceiver 513 is for bidirectional wireless communications with another wireless device. The transceiver 513 may provide frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. For the purposes of clarity, the description here separates the description of this signal processing from the RF and/or radio stage and conceptually allocates that signal processing to some analog baseband processing unit and/or the processor 515 or other central processing unit. In some embodiments, the transceiver 513, portions of the antenna unit 518, and an analog baseband processing unit may be combined in one or more processing units and/or application specific integrated circuits (ASICs).

The antenna unit 518 may be provided to convert between wireless signals and electrical signals, enabling the wireless apparatus 500 to send and receive information from a cellular network or some other available wireless communications network or from a peer wireless device. In an embodiment, the antenna unit 518 may include multiple antennas to support beam forming and/or multiple input multiple output (MIMO) operations. As is known to those skilled in the art, MIMO operations may provide spatial diversity and multiple parallel channels which can be used to overcome difficult channel conditions and/or increase channel throughput. The antenna unit 518 may include antenna tuning and/or impedance matching components, RF power amplifiers, and/or low noise amplifiers.

As shown in FIG. 5, the wireless apparatus 500 may further include a measurement unit 516, which measures the signal strength level that is received from another wireless device, and compare the measurements with a configured threshold. The measurement unit may be utilized by the wireless apparatus 500 in conjunction with various exemplary embodiments of the invention, as described herein.

Without in any way limiting the scope, interpretation, or application of the claims appearing below, a technical effect of one or more of the example embodiments disclosed herein is enhanced user experience with a user equipment due to automatic, service-aware power saving operations. Another technical effect of one or more of the example embodiments disclosed herein is an overall better load balancing and resource allocation load for an base station system.

Embodiments of the present invention may be implemented in software, hardware, application logic or a combination of software, hardware and application logic. The software, application logic and/or hardware may reside a base station, a mobility management entity or an access point. If desired, part of the software, application logic and/or hardware may reside on access point, part of the software, application logic and/or hardware may reside on a network element such as a UE, and part of the software, application logic and/or hardware may reside on a peer network element such as a base station, a mobility management entity or an access point. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising
establishing a plurality of mode priorities one for each of a plurality of technology modes supported by a user equipment (UE);
selecting a target technology mode that meets at least one current user service requirement of the user equipment and maximizes a power saving based at least in part on a mode priority associated with the target technology mode;
causing the user equipment to camp on the selected target technology mode; and
balancing a resource allocation based in part on the selected target technology mode.

2. The method of claim 1 wherein establishing the plurality of mode priority comprises at least
collecting a plurality of service usage data items from the user equipment over a period of time; and
updating a mode priority of a technology mode associated with each of the service usage data items either when the service usage data item is collected or at a predetermined interval.

3. The method of claim 2 wherein collecting the plurality of service usage data items comprises collecting at least one of a type of service used in a service session, a length of the service session, and a technology mode associated with the service usage data item.

4. The method of claim 3 wherein updating the mode priority comprises at least one of
updating the mode priority based at least in part on one subscribed services in a subscriber profile associated with the user equipment;
incrementing a service usage frequency for the technology mode; and
re-computing the mode priority based on the incremented service usage frequency.

5. The method of claim 3 wherein updating the mode priority comprises at least one of
setting an initial value for each of the plurality of mode priorities based on an estimated reliability measure;
resetting the mode priority to a predetermined initial value at a predefined interval based at least in part on one of a user preference and an operator preference; and
reinitiating the service profile for the user equipment.

6. The method of claim 3 wherein causing the user equipment to camp on the selected target technology mode comprises at least one of
causing the user equipment to camp on the selected target technology mode upon the UE entering an active state;
disabling at least one operation for each of the plurality of technology modes that is not the target technology mode if a priority mode associated with the technology mode reaches a low threshold and the user equipment is in an active state;
instructing the user equipment to enable at least one service associated with the selected target technology mode; and
enabling a power saving operation for the selected target technology mode.

7. The method of claim 6 wherein instructing the user equipment further comprises sending a radio resource control (RRC) message to the user equipment, the RRC message comprising at least one of a resource allocation update, a camp priority, and the selected target technology mode.

8. The method of claim 6 causing the user equipment to camp on the selected target technology mode further comprises performing measurements for a handover specific to the selected technology mode.

9. The method of claim 1 wherein disabling the at least one service comprises at least one of the following if the selected target technology mode is a 2^{nd} generation (2G) wireless technology:
stop taking measurements for 3^{rd} generation wireless technology (3G) handover if a priority mode for a 3G technology mode reaches a predetermined low threshold value; and
enabling a 2G power saving operation.

10. The method of claim 1 wherein balancing the resource allocation further comprises at least one of
allocating at least one resource for the selected technology mode; and
de-allocating at least one previously allocated resource for a de-selected technology mode.

11. The method of claim 1 wherein each of the technology modes comprises at least one of a radio access technology, a network technology, a service platform, and a technology standard.

12. An apparatus, comprising:
a service profile control module configured to
establishing a plurality of mode priorities one for each of a plurality technology modes supported by a user equipment; and
select a target technology mode that meets at least one current user service requirement of the user equipment and maximizes a power saving based at least in part on a mode priority associated with the target technology mode;
an interface module configured to cause the user equipment to
camp on the selected target technology mode; and
disable at least one operation for each of the plurality of technology modes that is not the selected target technology mode if a priority mode associated with the technology mode reaches a low threshold; and
a resource control module configured to
balance a resource allocation based in part on the selected target technology mode.

13. The apparatus of claim 12, wherein the service profile control module is further configured to
collect a plurality of service usage data items from the user equipment over a period of time; and
updating a mode priority of a technology mode associated with each of the service usage data items either when the service usage data item is collected or at a predetermined interval.

14. The apparatus of claim 12 wherein the service profile control module comprises at least one of a mode priority for each of the plurality technology modes supported by the user equipment and a plurality of handover parameters for each technology mode.

15. The apparatus of claim 12 wherein the mode priority is a ratio of a service usage frequency to an overall service usage frequency by the user equipment.

16. The apparatus of claim 12 wherein the service profile control module is further configured to select the target technology mode based at least in part on one or more services subscribed by the user equipment.

17. The apparatus of claim 12 wherein the service usage data item comprises at least a type of service used in a service session, a length of the service session, and a technology mode associated with the type of service wherein the type of service is one of a voice call, an instant message, a 3G data service, and a 2G data service.

18. The apparatus of claim 12 wherein the apparatus is part of a long-term evolution (LTE) evolution node B (NodeB), a LTE mobility management entity, and a 4^{th} generation (4G) wireless network element.

19. An apparatus, comprising:
at least one processor; and
at least one memory including computer program code
the at least one memory and the computer program code configured to, with the at least one processor, cause the apparatus to perform at least the following:
establishing a plurality of mode priorities one for each of a plurality technology modes supported by a user equipment;
selecting a target technology mode that meets at least one current user service requirement of the user equipment and maximizes a power saving based at least in part on a mode priority associated with the target technology mode;
causing the user equipment to camp on the selected target technology mode; and
balancing a resource allocation based in part on the selected target technology mode.

20. The apparatus of claim 19 wherein the at least one memory and the computer program code configured to, with the least one processor, cause the apparatus to further perform at least one of
collecting a plurality of service usage data items from the user equipment over a period of time;
updating a mode priority for at least one of the technology modes in a service profile of the user equipment when each of the plurality of service usage data items is collected or at a predetermined interval; and
disabling at least one operation for each of the plurality of technology modes that is not the selected target technology mode if an priority mode associated with the technology mode reaches a low threshold.
